(19) United States
(12) Patent Application Publication
(10) Pub. No.: US 2025/0036493 A1
(43) Pub. Date: Jan. 30, 2025

(54) METHODS AND SYSTEMS FOR MANAGEMENT OF DEVICE NOTIFICATIONS BASED ON PROXEMIC PROBABILITY DENSITY FUNCTION

(71) Applicants: Roeland Petrus Hubertus VERTEGAAL, Markham (CA); David HOLMAN, Markham (CA); Zafeirios FOUNTAS, London (GB); Aneesh Pradyumna TARUN, Markham (CA)

(72) Inventors: Roeland Petrus Hubertus VERTEGAAL, Markham (CA); David HOLMAN, Markham (CA); Zafeirios FOUNTAS, London (GB); Aneesh Pradyumna TARUN, Markham (CA)

(21) Appl. No.: 18/360,429

(22) Filed: Jul. 27, 2023

(51) Int. Cl. G06F 9/54; G06F 9/48

(52) U.S. Cl. CPC G06F 9/542; G06F 9/48

(57) ABSTRACT

Methods and devices for management of notifications at an electronic device are disclosed. Sensed data is obtained representing a sensed location of the user and at least one other human or device. A first proxemic probability density function (PDF) is defined using the sensed location of the user and at least one other proxemic PDF is defined using the sensed location of the at least one other human or device. An entropy metric is generated representing likelihood of interaction between the user and the at least one other human or device by computing an overlap between the first proxemic PDF and the other proxemic PDF. In response to the entropy metric exceeding a defined threshold, the electronic device transitions from a default mode to an engaged mode, wherein in the engaged mode the electronic device is controlled to provide at least one output differently than in the default mode.

### CROSS-REFERENCE TO RELATED APPLICATIONS

This is the first application for the present disclosure.

### BACKGROUND

Proliferation of end user electronic devices (e.g., smartphones, smart watches, etc.) and device-generated outputs (e.g., notifications from software applications, video and/or audio media, etc.) have led to increased demand for user attention. Accordingly, there has been interest in solutions that can help the user to manage their cognitive load, for example by determining whether or not a notification should be generated by the device.

However, existing solutions may be invasive of user privacy, require extensive use of external sensors and/or are computationally complex. Therefore, improvements to management of device notifications would be useful.

### SUMMARY

In various examples, the present disclosure describes methods and systems that enable management of device notifications and/or media output, based on a proxemic probability density function.

In an example aspect, the present disclosure describes a method, at an electronic device associated with a user, the method including: obtaining, from one or more sensors, sensed data representing a sensed location of the user and at least one other human or at least one other device; defining a first proxemic probability density function (PDF) representing likelihood of interaction in a personal space of the user, the first proxemic PDF being defined using the sensed location of the user; defining at least one other proxemic PDF representing likelihood of interaction with the at least one other human or the at least one other device, the at least one other proxemic PDF being defined using the sensed location of the at least one other human or the at least one other device; generating an entropy metric representing likelihood of interaction between the user and the at least one other human or the at least one other device by computing an overlap between the first proxemic PDF and the at least one other proxemic PDF; and in response to the entropy metric exceeding a defined threshold, transition the electronic device from a default mode to an engaged mode, wherein in the engaged mode the electronic device is controlled to provide at least one output differently than in the default mode.

In an example of the preceding example aspect of the method, the first proxemic PDF may be defined to be a Gaussian distribution having a mean based on the sensed location of the user.

In an example of any of the preceding example aspects of the method, the first proxemic PDF may be defined to comprise two or more constituent PDFs, wherein each constituent PDF represents likelihood of a respective type of interaction in the personal space of the user.

In an example of the preceding example aspect of the method, at least one constituent PDF may represent likelihood of an interpersonal interaction and at least one other constituent PDF may represent likelihood of a peripersonal interaction.

In an example of some of the preceding example aspects of the method, the first proxemic PDF may be a mixed Gaussian distribution and each of the two or more constituent PDFs may be a respective Gaussian distribution.

In an example of any of the preceding example aspects of the method, a standard deviation of the first proxemic PDF may be adjusted based on at least one of: an estimated arm length of the user or changes in the sensed location of the user.

In an example of any of the preceding example aspects of the method, the at least one other proxemic PDF may represent likelihood of interaction with the at least one other human, and the at least one other proxemic PDF may be defined to be a Gaussian distribution having a mean based on the sensed location of the at least one other human.

In an example of the preceding example aspect of the method, a standard deviation of the at least one other proxemic PDF may be adjusted based on at least one of: an estimated arm length of the at least one other human or changes in the sensed location of the at least one other human.

In an example of some of the preceding example aspects of the method, the entropy metric may represent likelihood of a particular type of interaction with the at least one other human, and the electronic device may be transitioned to the engaged mode dependent on the type of interaction.

In an example of some of the preceding example aspects of the method, the electronic device in the engaged mode may be controlled to receive voice input from the at least one other human, and wherein audio output of the electronic device may be proportional to the entropy metric.

In an example of some of the preceding example aspects of the method, the sensed data may represent sensed locations of a plurality of other humans, wherein there may be a respective plurality of other proxemic PDFs representing likelihood of interaction with the respective plurality of other humans, and wherein the entropy metric may be generated based on overlaps between the first proxemic PDF and each other proxemic PDF.

In an example of the preceding example aspect of the method, in response to the entropy metric indicating significant overlaps between the first proxemic PDF and two or more other proxemic PDFs corresponding to two or more other humans, the electronic device may be transitioned to the engaged mode wherein the electronic device may be controlled to interact with two or more other devices associated with the two or more other humans.

In an example of the preceding example aspect of the method, the electronic device may be controlled to initiate a peer-to-peer session with the two or more other devices.

In an example of a preceding example aspect of the method, the electronic device may be controlled to serve as an access point for the two or more other devices.

In an example of some of the preceding example aspects of the method, the at least one other proxemic PDF may represent likelihood of interaction with the at least one other device, and the at least one other proxemic PDF may be defined to be a Gaussian distribution having a mean based on the sensed location of the at least one other device.

In an example of the preceding example aspect of the method, in response to the entropy metric exceeding the defined threshold, the at least one other device may be controlled to activate a microphone.

In an example of a preceding example aspect of the method, the sensed data may represent sensed locations of a plurality of other devices, wherein there may be a respective plurality of other proxemic PDFs representing likelihood of interaction with the respective plurality of other devices, and wherein a respective plurality of entropy metrics may be generated to represent likelihood of interaction with the respective plurality of other devices.

In an example of the preceding example aspect of the method, each of the plurality of entropy metrics may be compared with the defined threshold to determine which of the plurality of other devices is likely to be an interaction target of the user.

In an example of any of the preceding example aspects of the method, the entropy metric may be represented in binary bits.

In an example of any of the preceding example aspects of the method, in the engaged mode the electronic device may be controlled to adjust the at least one output proportionate to a value of the entropy metric.

In an example of the preceding example aspect of the method, the at least one output may be an audible output and a noise cancellation level of the at least one output may be adjusted proportionate to the value of the entropy metric.

In an example of some of the preceding example aspects of the method, in the engaged mode the electronic device may be controlled to change an output modality of the at least one output.

In an example of some of the preceding example aspects of the method, in the engaged mode the electronic device may be controlled to change the at least one output to indicate an engaged status.

In an example of some of the preceding example aspects of the method, in the engaged mode the electronic device may be controlled to mute, hide or delay providing the at least one output.

In an example of any of the preceding example aspects of the method, the sensed data may exclude camera data, eyetracking data or physiological data.

In another example aspect, the present disclosure describes an electronic device including: a processing unit; and a memory including instructions that, when executed by the processing unit, cause the electronic device to perform any preceding examples of the preceding example aspects of the methods.

In another example aspect, the present disclosure describes a non-transitory computer readable medium having machine-executable instructions stored thereon, wherein the instructions, when executed by an electronic device, cause the electronic device to perform any preceding examples of the preceding example aspects of the methods.

In another example aspect, the present disclosure describes a processing module configured to control an electronic device to cause the electronic device to carry out any preceding examples of the preceding example aspects of the methods.

In another example aspect, the present disclosure describes a system chip including a processing unit configured to execute instructions to cause an electronic device to carry out any preceding examples of the preceding example aspects of the methods.

In another example aspect, the present disclosure describes a computer program characterized in that, when the computer program is run on a computer, the computer is caused to execute any preceding examples of the preceding example aspects of the methods.

### BRIEF DESCRIPTION OF THE DRAWINGS

Reference will now be made, by way of example, to the accompanying drawings which show example embodiments of the present application, and in which:

FIG. 1 is a block diagram illustrating an example electronic device, in accordance with examples of the present disclosure;

FIG. 2 is a 2D plot illustrating an example social space proxemic probability density function, in accordance with examples of the present disclosure;

FIG. 3 is a 2D plot illustrating an example simplified proxemic probability density function, in accordance with examples of the present disclosure;

FIG. 4 is a 3D plot illustrating an example overlap between two proxemic probability density functions, in accordance with examples of the present disclosure;

FIG. 5 is a 2D plot illustrating another example overlap between two proxemic probability density functions, in accordance with examples of the present disclosure; and

FIG. 6 is a flowchart illustrating an example method for managing notifications based on proxemic probability density functions, in accordance with examples of the present disclosure.

### DETAILED DESCRIPTION

Examples of the present disclosure describe methods and systems for notification management on an electronic device, including end user devices such as smartphones, smart watches, tablets, etc.

Some existing solutions attempt to manage device notifications using different techniques to determine whether or not the user is or is likely to be busy. For example, an existing solution is to analyze events in the user's calendar application, frequency of emails and email replies to specific senders to estimate a cost (e.g., cost to user's attention) of generating a message notification. Another existing solution is to measure sound patterns in the user's environment together with sensing eye contact to estimate whether a user is in a conversation and thus whether a notification should be generated. Yet another existing solution is to use cameras in the user's environment together with fiducial markers to track users in the environment and estimate whether users are in conversation with each other, in order to control whether to output conversations in headphones.

Some existing solution may have drawbacks in that they may be invasive of user privacy, for example by requiring the use of cameras to monitor the user and their environment, or by analyzing multiple sources of user data (e.g., calendar application, email application, etc.). Another drawback is that some existing solutions may be computationally complex, for example requiring analysis of disparate sources of user data. Additionally, some existing solutions may require the use of costly hardware, such as the use of cameras and markers to track users in an environment. The use of cameras to track users can also suffer from problems of occlusion, poor lighting and/or poor camera placement, for example.

In various examples, the present disclosure makes use of sensors available on many existing electronic devices to sense a user's immediate environment and compute a proxemic probability density function that may represent a likelihood of interaction with another human in the user's proximity. Compared to some existing solutions discussed above, the present disclosure may enable management of device notifications, based on an estimation of the user's cognitive load, without requiring access to user data (which may be invasive of the user's privacy) and without requiring the use of external cameras to track the user's environment (which may be expensive and may also have privacy implications).

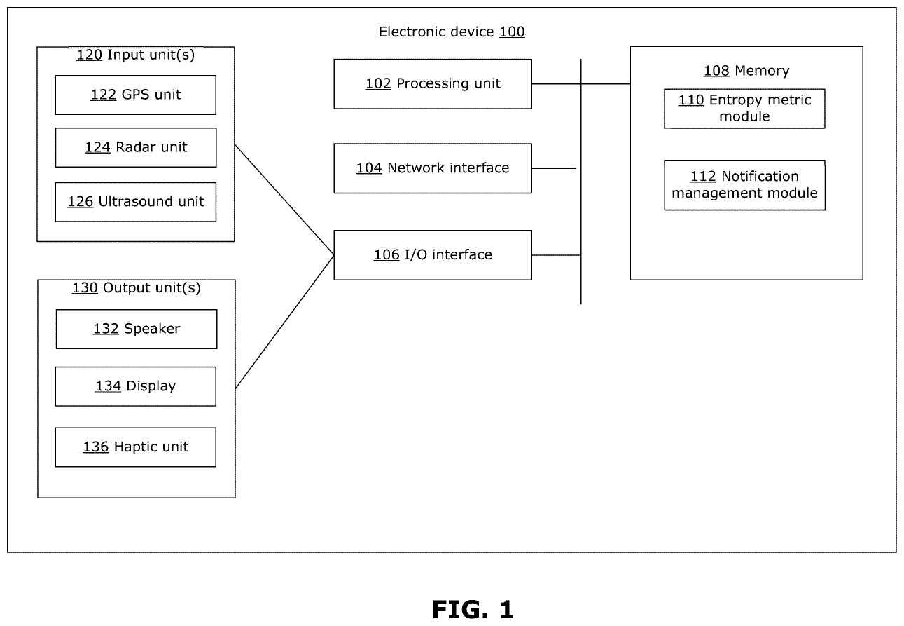

To assist in understanding the present disclosure, FIG. 1 is described first.

FIG. 1 is a block diagram showing some components of an electronic device 100, in which examples of the present disclosure may be implemented. Although FIG. 1 shows a single instance of each component, there may be multiple instances of each component shown.

The electronic device 100 includes at least one processing unit 102, such as a processor, a microprocessor, an application-specific integrated circuit (ASIC), a field-programmable gate array (FPGA), a dedicated logic circuitry, a dedicated artificial intelligence processor unit, or combinations thereof.

The electronic device 100 includes at least one network interface 104 for wired or wireless communication with a network (e.g., an intranet, the Internet, a P2P network, a WAN and/or a LAN) or other node. The network interface 104 may include wired links (e.g., Ethernet cable) and/or wireless links (e.g., one or more antennas) for intra-network and/or inter-network communications. The electronic device 100 may transmit and receive communications with another electronic device via the network interface 104.

The electronic device 100 also includes at least one input/output (I/O) interface 106. The I/O interface 106 may interface with one or more input units 120, such as a microphone, keyboard, mechanical buttons, etc. The input devices may include one or more sensors such as a Global Positioning System (GPS) unit 122, a radar unit 124 and/or an ultrasound unit 126, among other possibilities. The sensors may each generate sensed data, which may be processed by the processing unit 102, as disclosed herein. The I/O interface 106 may also enable the electronic device 100 to receive sensed data from external or remote input units, such as a wirelessly connected camera. The I/O interface 106 may also interface with one or more output units 130, such as a speaker 132, a display 134 and/or a haptic unit 136, among other possibilities. The I/O interface 106 may also enable the electronic device 100 to interface with external or remote output units, such as wirelessly connected headphones. The electronic device 100 may include or may couple to other input units and/or other output units.

The electronic device 100 includes at least one memory 108, which may include a volatile or non-volatile memory (e.g., a flash memory, a random access memory (RAM), and/or a read-only memory (ROM)). The non-transitory memory 108 may store instructions for execution by the processing unit 102, such as to carry out examples described in the present disclosure. For example, the memory 108 may include instructions for executing an entropy metric module 110 and a notification management module 112, among others (e.g., software applications, an operating system, etc.). The memory 108 may also include data, such as media that may be outputted by an output unit 130.

In some examples, the electronic device 100 may also include one or more electronic storage units (not shown), such as a solid state drive, a hard disk drive, a magnetic disk drive and/or an optical disk drive. In some examples, one or more data sets and/or modules may be provided by an external memory (e.g., an external drive in wired or wireless communication with the electronic device 100) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The components of the electronic device 100 may communicate with each other via a bus, for example.

The input units (e.g., sensors) of the electronic device 100 may enable sensing of objects relative to the electronic device 100 with relatively high precision. For example, the radar unit 124 may be an ultrawide band (UWB) radar unit (e.g., enabling UWB indoor positioning) which may enable short-range (e.g., within about 100 m radius), real-time locating of objects in the environment with relatively high precision (e.g., within about 10 cm). The ultrasound unit 126 may use ultrasound to similarly sense objects in the nearby environment with relatively high precision. The GPS unit 122 may similarly use GPS technology to determine the location of the electronic device 100 with relatively high precision and accuracy. Although the electronic device 100 is illustrated with the GPS unit 122, radar unit 124 and ultrasound unit 126, it should be understood that there may be greater or fewer number of sensors in the electronic device 100 and the electronic device 100 may additionally or alternatively receive sensed data from external sensors. A non-limiting example of such external sensor is a millimeter-wave (mmWave) radar station commonly in use for home automation zone detection. In general, the electronic device 100 may obtain sensed data from various internal or external sensors or positioning systems.

In addition to sensing objects in the environment, if there are two electronic devices 100 in proximity to each other and the two electronic devices 100 each having such sensors, the relative orientation between the two electronic devices 100 may be detected using sensed data from the sensors.

In general, the relative distance and orientation between two people may be used to estimate the probability that the two people are interacting with each other (e.g., having a conversation). Based on the probability of interaction, the cost (e.g., in terms of cognitive load to a user) of generating a notification to one of the users may be estimated. Thus, device notifications to a user (e.g., a user of the electronic device 100) may be managed based on a probability, calculated using sensed data, of the user being in an interaction with another person (who may or may not be a user of another electronic device). For example, if there is a high probability that the user is interacting with another person, notifications may be muted on the electronic device 100. It should be noted that, in addition to or alternative to management of device notifications, other types of device outputs, such as output of media, may be managed based on the probability of interaction. In some examples, management of device outputs may be performed in coordination with device inputs. For example, sound received by a microphone input device may be outputted via a headphone output unit, amplifying the sound and acting as a hearing aid. Such embodiments may be useful for users who are hard of hearing, or to enable low-volume communications between two people.

In various examples, the present disclosure defines a proxemic probability density functions (PDFs) that may be used as a probabilistic model representing the personal space of a user of an electronic device. Based on the use of proxemic PDFs, a proxemics risk function may be computed and used as a means of estimating the risk that the user is interacting (e.g., having a conversation) with another human (who may or may not be another user of another electronic device). This risk may predict the cognitive load for the user as it may provide a spatial metric for the uncertainty that the user is communicating or interacting in some form with another human or device.

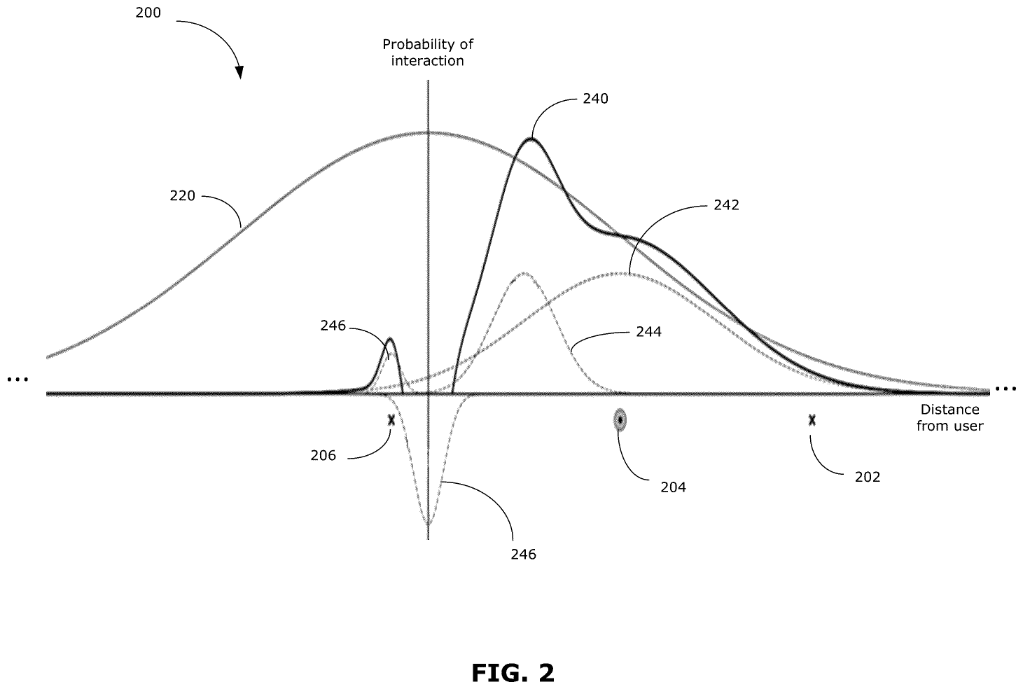

FIG. 2 is a plot 200 illustrating the use of proxemic PDFs to represent likelihood of interaction in a user's personal space. In general, likelihood of interaction in a personal space of a user may be modeled using a PDF based on a normal distribution describing the probability of interaction. A detailed probabilistic model is illustrated in FIG. 2, which may model likelihood of interaction in a user's personal space using a combination of different PDFs that each represent the likelihood of different types of interactions with the user.

In the example plot 200, the horizontal axis indicates the x-distance from a user (where the centroid of the user is located at x=0) and the vertical indicates the probability of being in an interaction with the user. It may be noted that the location of the electronic device 100 (e.g., as determined using sensors of the electronic device 100, such as using the GPS unit 122) may be used as a proxy for the location of the user. The positive x direction indicates a distance in front of the user and the negative x direction indicates a distance behind the user. The horizontal axis of the plot 200 is scaled relative to the user, with a first distance 202 being a distance of two arm lengths from the user, a second distance 204 being a distance of one arm length (or touching distance) from the user, and a third distance 206 being a shoulder tap distance from the user. It should be noted that although the plot 200 only illustrates the x-distance from the user, the user may be moving in two dimensions (x and y directions) such that the proxemic PDFs described below may be actually 3D surfaces (rather than 2D curves) representing a probability of interaction over a 2D space that include both x and y directions. That is, the plot 200 may illustrate only a cross-section along y=0 of the proxemic PDFs described below.

The personal space of the user may be modeled by a social space PDF 240 (indicated by a dark solid line) and an auditory range PDF 220 (indicated by a light solid line). The social space PDF 240 may be a combination of two or more constituent PDFs. The social space PDF 240 in this example is a summation of an interpersonal space PDF 242, a peripersonal space PDF 244, and a behind user space PDF 246. Each of these three constituent PDFs 242, 244, 246 describes the likelihood of the user being in an interaction (e.g., conversation) when another human moves into that part of the user's personal space. Each of the three constituent PDFs 242, 244, 246 may correspond to a respective type of personal space around the user. The interpersonal space PDF 242 thus represents likelihood of interaction with another human in the user's interpersonal space.

In the present disclosure, a user's interpersonal space may be defined as the space surrounding the user in which the user is comfortable communicating with another human; for example, the user's interpersonal space may extend to about two arms lengths in front of the user. A user's peripersonal space may be defined as the space surrounding the user where the user can touch or be touched by another entity (e.g., another human or an object in the environment); for example, the user's peripersonal space may extend to about one arm length in front of the user. The behind user space may be defined as the space behind the user where another human may touch the user; the behind user space is typically smaller than the peripersonal space. It should be appreciated that although the concept of interpersonal space, peripersonal space and behind user space may be generally applicable to most or all users, the exact spatial definition of these spaces (e.g., how far the interpersonal space or peripersonal space extends from the user) may vary based on cultural practices, the user's personal comfort levels, physical limitations, etc.

For example, the interpersonal space PDF 242 may represent the likelihood of interaction in front of the user in which the user is likely to be able to talk to one or more other humans. The area covered by the interpersonal space PDF 242 may be determined statically for example by extending the interpersonal space PDF 242 to a predefined and fixed first distance 202 (which may correspond to two arm lengths of an average adult), or may be determined dynamically for example by using actual measurements of the arm length of the user (e.g., by sensing a distance between the electronic device 100 held near the user's body and a sensor on a smartwatch at the end of the user's extended arm) and multiplying by two.

The peripersonal space PDF 244 may represent the likelihood of interaction in a space in which the user is likely to be able to touch. Similar to the interpersonal space PDF 242, the area covered by the peripersonal space PDF 244 may be determined statically for example by extending the peripersonal space PDF 244 to a predefined and fixed second distance 20 (which may correspond to one arm length of an average adult), or may be determined dynamically for example by using actual measurements of one arm length of the user (e.g., by sensing a distance between the electronic device 100 held near the user's body and a sensor on a smartwatch at the end of the user's extended arm).

The behind user space PDF 246 may represent the likelihood of interaction behind the user (e.g., where another human may approach and physically touch the user). The PDF representing the likelihood of interaction in this area is of a smaller magnitude to represent the smaller but non-zero chance of interaction.

A negative PDF 246 representing the user's physical body is subtracted from the summation of the three constituent PDFs 242, 244, 246 (since another human cannot occupy the same physical space as the user, the probability of the user interacting with another human in the space covered by the negative PDF 246 should be zero or close to zero). The resulting social space PDF 240 has a large lobe in the direction in front of the user and a smaller lobe in the direction behind the user.

It may be noted that the auditory range PDF 220 is symmetric and centered on the user. The auditory range PDF 220 may be useful for estimating the likelihood of an auditory interruption. In some examples of the present disclosure, the user's personal space may be modeled using only the social space PDF 240. In other examples, the user's personal space may be modeled using only the auditory range PDF 220, or a combination of the auditory range PDF 220 with the social space PDF 240. For example, less precise sensors of the user's electronic device 100 may detect if another human is within the auditory range PDF 220, and if another human is detected in this area more precise sensors may be used to more precisely determine the distance between the user and the other human. In this way, the auditory range PDF 220 may be used as a coarse estimate of interaction that may be used to determine whether more precise estimation of interaction is necessary. This may be useful to help save on computational resources and/or power consumption by avoiding the need for more precise sensors to be in use when no human has been detected within the auditory range PDF 220. In a non-limiting example, the auditory range PDF 220 could be used to estimate the likelihood of the user's interaction with a device (e.g., a voice assistant device or smart speaker in an Internet of Things (IoT) environment) and thus may be used to determine whether the device should activate its microphone to start listening to sounds from the user, thus enhancing user privacy. In another example, the auditory range PDF 220 can also be used to estimate the likelihood of the user's interaction with a particular device in an IoT environment, in order to determine which device is likely to be an interaction target and a likely intended recipient of a verbal command.

The centroid of the social space PDF 240 may be located at the center of the user's location, for example based on a positioning sensor (e.g., GPS unit 122, radar unit 124 and/or ultrasound unit 126) of the electronic device 100 (where the location of the electronic device 100 is used as a proxy for the location of the user). The orientation of the social space PDF 240 (e.g., the direction that is considered to be in front or behind of the user) may be determined based on the orientation sensed by an orientation sensor (e.g., GPS unit 122, radar unit 124 and/or ultrasound unit 126) of the electronic device 100 (where the orientation of the electronic device 100 is used as a proxy for the orientation of the user). As previously mentioned, the electronic device 100 may have such sensors internally or may receive sensor data from remote sensors (e.g., from sensors of a wearable device such as headphones, clip, smartwatch, smartglasses, etc.).

Generally, the standard deviation of the social space PDF 240 may correspond to the arm length of the user (e.g., about 70 cm for an average adult). The overall standard deviation of the social space PDF 240 may be adjusted, for example based on the change in the user's sensed position over a defined time period (e.g., over 1 s). The standard deviation of the change in the user's position over the time period may be understood to be proportional to the velocity of the user over that time period. Assuming that the user is moving in two dimensions and mainly in a forward direction (i.e., a direction towards the front of the user) rather than sideways or backward directions, this means the forward direction of movement would result in a larger forward probability of interaction than a lateral (i.e., sideways) probability of interaction. In response, the standard deviation of the social space PDF 240 in the forward direction may be adjusted to be larger than the standard deviation of the social space PDF 240 in a backward direction or in a lateral direction. This may be interpreted to represent a different likelihood of interaction based on whether the user is merely passing by another human or walking forward (and potentially stopping) to enter into an interaction (e.g., a conversation) with another human. In the case of passing by, the narrower lateral standard deviation would indicate a reduced chance of interaction. It should be noted that this adjustment in standard deviation of the social space PDF 240 may be dynamic and real-time (or near real-time), such that the social space PDF 240 may be changing in real-time in response to the user's detected movements (e.g., detected by sensors of the electronic device 100 or other sensors in the environment).

Because the presence of other humans in the user's personal space may be quickly changing (e.g., due to movement of other humans in the environment and/or the user's movement through the environment), it is important for the social space PDF 240 to be defined in real-time and for the standard deviation of the social space PDF 240 to be adjusted in real-time, in order to be an accurate reflection of the user's situation. For example, if the standard deviation of the social space PDF 240 increases in real-time as the user walks towards another human, the other human will be within the social space PDF 240 earlier than if the standard deviation was static. The practical effect is that the likelihood of an interaction with the other human may be detected earlier and notifications on the user's electronic device 100 may be managed in a way that is more responsive to the likely interaction (e.g., audible notifications may be muted earlier). In another example, by dynamically adjusting the standard deviation in the lateral direction to be narrower (due to the user's forward motion), the inadvertent activation of nearby voice-sensing devices (e.g., smart speakers) may be avoided. This may help to enhance the user's privacy and/or may help to reduce unnecessary power consumption. Solutions that rely on manual means (e.g., manually defining the social space PDF 240 and/or manually adjusting the standard deviation) is not practical and would not achieve real-time adaptability. Further, the use of a computer-based electronic device 100 for defining the social space PDF 240 is an integral part of the disclosure at least because the information that is processed, such as sensor data, positioning data, communication of relative distance with another device, requires the use of a computer.

The likelihood of the user being in an interaction with another user may be estimated based on the overlap between the social space PDF 240 (or any one of the constituent PDFs 242, 244, 246) and another PDF representing another human (discussed further below).

In general, the personal space of the user may be modeled with greater detail than the personal space of other humans in the user's proximity. Simplifying the probabilistic model representing the personal space of other humans may help to simplify computations (e.g., in a crowded environment, it may be more feasible to use a simplistic model for many other humans), which may help to speed up processing and thus help enable notification management that is responsive to real-time changes in the user's environment. Additionally, a simplistic model of the personal space of another human may be appropriate where the orientation of the other human (e.g., the direction the other human is facing) is not detectable by the sensors of the electronic device 100.

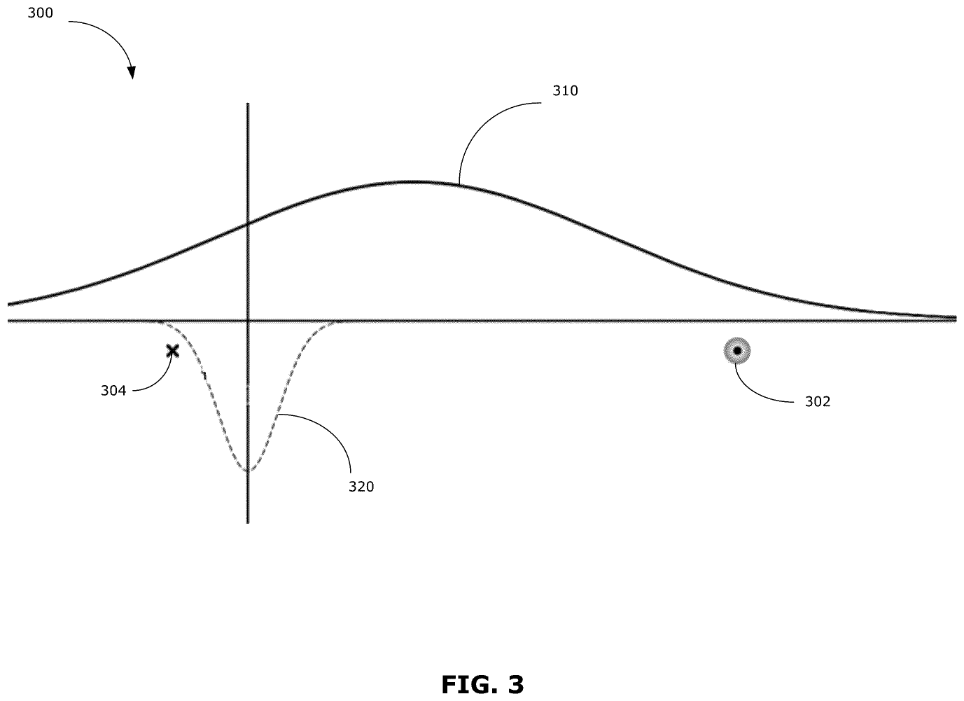

FIG. 3 is a plot 300 illustrating the use of a simple proxemic PDF to represent likelihood of interaction in the proximity of another human who is not the user of the electronic device 100 (although the other human may be a user of a different electronic device). The likelihood of interaction in the proximity of the other human may be modeled using a relatively simple probability distribution based on a Gaussian distribution, for example. Rather than being representative of a social space, the simple proxemic PDF illustrated in FIG. 3 may be representative of the probability of the other human's presence at a location in space (relative to the human's current location).

Similar to the example of FIG. 2, the plot 300 in FIG. 3 shows a proxemic PDF 310 representing likelihood of interaction in the proximity of the other human, where probability of interaction is represented in the vertical axis and x-distance relative to the center of the other human is represented in the horizontal axis (i.e., the centroid of the other human is located at x=0 in the plot 300 of FIG. 3). The location of the centroid of the other human may be detected by sensors of the electronic device 100 of the user, or by other sensors in the environment, as discussed further below. The horizontal axis of the plot 300 may be scaled relative to the other human, with a first distance 302 being a distance of one arm length (or touching distance) from the other human, and a second distance 304 being a shoulder tap distance from the other human. A negative PDF 320 may represent no interaction the space occupied by the physical body of the other human.

In some examples, the standard deviation of the proxemic PDF 310 may be adjusted in real-time based on changes in the sensed position of the other human over a defined time period (e.g., over 1 s), in a manner similar to that discussed above with respect to the social space PDF 240.

In some examples, the likelihood of interaction in the proximity of the other human may be represented using a more detailed social space PDF similar to that of FIG. 2. In some examples, the likelihood of interaction in the proximity of the other human may be represented using an even further simplified representation that may be simply based on an estimated distance and angle between the user and the other human.

Similar to the social space PDF 240, the proxemic PDF 310 of the other human is offset towards the front (i.e., towards the positive x-direction) to indicate increased probability of interaction in front of the other human, compared to interaction behind the other human.

Although the more detailed social space PDF 240 is described as being used for the user of the electronic device 100 and the simplified proxemic PDF 310 is described as being used for other users in the vicinity of the user, this is not intended to be limiting. For example, the detailed social space PDF 240 or the simplified proxemic PDF 310 may be independently used to represent likelihood of interaction for any human (user or otherwise) in an environment.

Both the social space PDF 240 and the proxemic PDF 310 are bivariate distributions that describe a 3D probability function in the space around a human. When the human moves in a given direction (typically a forward direction, however movement in a backward, sideways or diagonal direction may also be possible), the standard deviation of the PDF 240, 310 increases in the direction of motion to represent the increased uncertainty in position over time in that direction.

It should be noted that each PDF (whether the more detailed social space PDF 240 or the simplified proxemic PDF 310) is centered on a respective human (whether the user of the electronic device 100 or another human) and has a directionality based on the orientation of the human. The location of the centroid of a PDF is thus based on the location of the corresponding human, which may be determined using any suitable positioning sensor, such as the GPS unit 122, radar unit 124, ultrasound unit 126, or other sensors (including other sensors of the electronic device 100 or external sensors or positioning systems in the environment, such as but not limited to mmWave unit(s)). The orientation may be similarly detected using any suitable positioning sensor.

The amount of overlap between two (or more) PDFs corresponding to respective two (or more) humans may be used to estimate the likelihood of interaction between the two (or more humans).

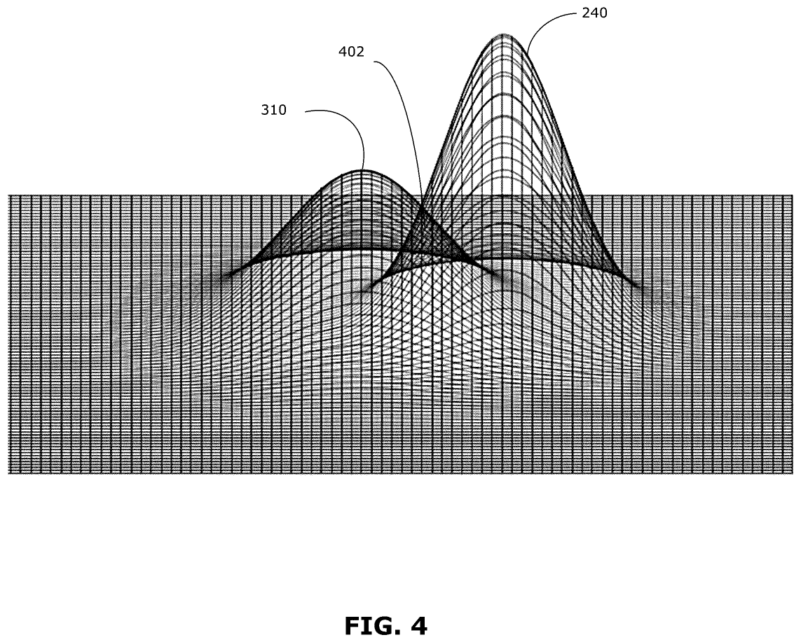

FIG. 4 is a 3D illustration of an example of how two PDFs corresponding to two humans (e.g., a first PDF 402 corresponding to a user of the electronic device 100 and a second PDF 404 corresponding to another human) may overlap. The overlapping region 406 may be calculated and used as an estimate of the likelihood that the two humans are in an interaction (e.g., conversation) with each other. The first PDF 402 corresponding to the user of the electronic device 100 may be the social space PDF 240 (i.e., the summation of constituent PDFs 242, 244, 246), or may be any one of the constituent PDFs 242, 244, 246. The second PDF 404 corresponding to the other human may be the simplified proxemics PDF 310.

It should be noted that, although FIG. 4 shows the first PDF 402 overlapping with only the second PDF 404, there may be additional PDFs (corresponding to additional humans) that overlap with the first PDF 402. For example, if the user is in the proximity of two or more other humans, the PDF corresponding to each respective human may overlap with the first PDF 402 and the amount of overlap may be used to estimate the likelihood that the user is in an interaction with that respective human. The determination that the user is likely to be in an interaction with a particular human (rather than another human in the user's proximity) may be used by the electronic device 100 to cooperate with a device of that particular human, for example to initiate a peer-to-peer (P2P) session with the other device or to output sounds received at a microphone of the other device. In some examples, if the first PDF 402 significantly overlaps (e.g., more than a defined overlap amount) with multiple other PDFs corresponding to multiple other humans, this may be indicative of a meeting between the user and multiple other humans. The determination that the user is likely to be in a meeting with multiple other humans may cause the electronic device 100 to automatically cooperate with multiple devices of those other humans in the meeting, for example to enable data sharing among the devices or to act as an access point for the other devices. It should be understood that these examples are not intended to be limiting.

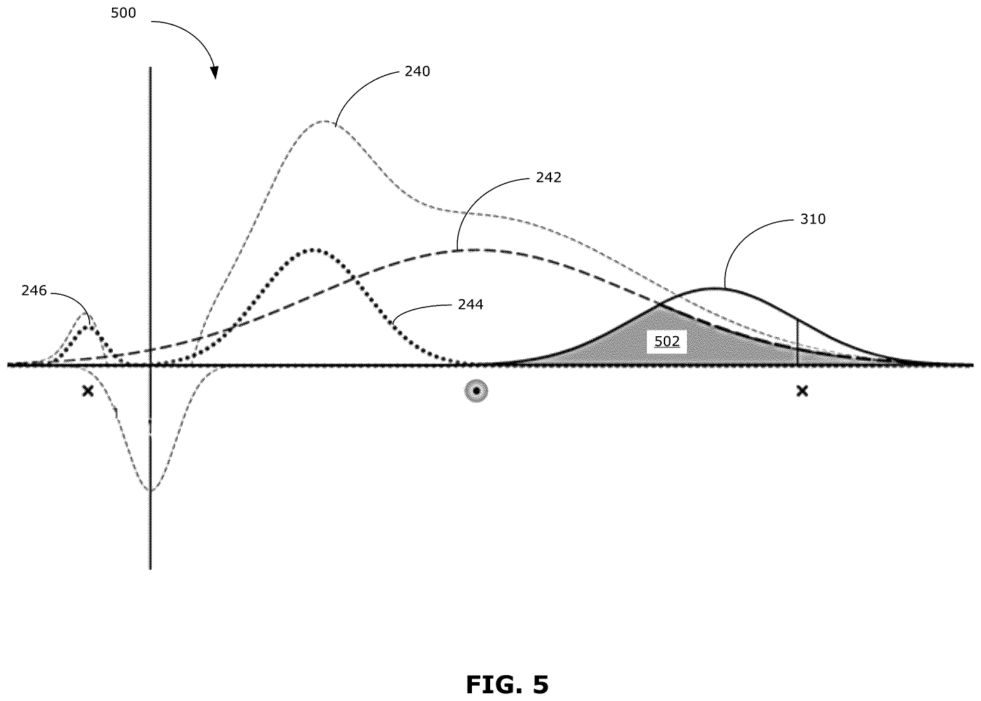

FIG. 5 is a 2D plot 500 that more clearly illustrates an overlap between a first PDF of the user of the electronic device 100 and a second PDF of the other human.

The example plot 500 illustrates the social space PDF 240 corresponding to the user as well as the constituent PDFs 242, 244, 246 representing likelihood of interaction within talking distance, touching distance, and shoulder tap distance, respectively. The example plot 500 also illustrates the simplified proxemic PDF 310 corresponding to the other human.

An example computation of the overlap between a first PDF of the user and a second PDF of the other human is now described. As previously noted, multiple PDFs corresponding to multiple humans may overlap with the first PDF of user, in which case the computation of overlap may be more complex than that described below. Various techniques may be used to compute the amount of overlap in such a scenario, for example using a Riemann Sum (which approximates an integral using a finite sum).

As illustrated by FIG. 5, the possibility of interaction between the user and another human may be estimated by computing an overlap 502 between a first PDF of the user (in this example, the constituent interpersonal space PDF 242), and the simplified proxemic PDF 310 of the other human). This overlap 502 represents the probability that the other human is within the interpersonal space of the user thus enabling interactions (e.g., a conversation) with the user. In this example, the overlap 502 is computed between the constituent interpersonal space PDF 242 rather than the more complex social space PDF 240, which may be less computationally complex. For example, computing an overlap between two Gaussian distributions may be simpler than computing an overlap between mixed Gaussians (which may involve a Riemann Sum). Because the social space PDF 240 is a summation of simple Gaussian PDFs 242, 244, 246, it may be more computationally efficient (e.g., requiring fewer computing resources, less memory and/or less power) to compute overlap between the proxemic PDF 310 of the other human (which is a Gaussian distribution) and each constituent PDF 242, 244, 246 individually.

The amount of overlap 502 (i.e., the volume that is bounded by the first PDF of the user, the second PDF of the other human, and the x-y plane) represents a statistical probability of interaction between the user and the other human. The amount of overlap 502 may be calculated using various suitable methods, including but not limited to the Kullback-Leibler (KL) divergence, Jensen-Shannon Divergence, or by computing the surface area delineated by the intersection of the mean of one PDF into the other PDF. In some examples, the KL divergence may be useful to represent the likelihood of interaction using bits, which may have applications for active inference reasoning. For example, bit-based representation may be convenient for summing probabilities of overlaps with different PDFs, to arrive at a total likelihood of interaction. In another example, bit-based summation may be convenient for estimating a total cognitive load of the user due to different humans in the user's personal space.

In some examples, the amount of overlap 502 may be computed by relating two cumulative density functions (CDFs), denoted CDF₁ and CDF₂ where:

$$f ( x , y ) = ( g ( s ) , h ( s ) ) and g ( s ) = C D {F}_{1} and h ( s ) = C D {F}_{2}$$

It may be noted that the PDF is the derivative of the CDF, meaning CDF is the equivalent of summing the probabilities of the PDF across the x-axis. That is, CDF₁ and CDF₂ may be thought of as respective integrals of two respective PDFs. The function ƒ may also be referred to as a probability-probability plot (P-P plot), and may represent the similarity between the two CDFs.

The overlap 502 may then be computed by computing the integral of ƒ, which will vary between 0 and 1.0. It may be noted that when the means of two (or more) distributions perfectly overlap, the integral of ƒ, which is the computed overlap 502, will always produce a value of 0.5, regardless of the shape of the distributions. The overlap 502 may be normalized to make it one-tailed, meaning that the overlap 502 will always equal 1.0 when two (or more) distributions perfectly overlap. Such a property may be useful because the overlap 502 may be directly representative of a probability, for example when the PDFs of the user and the other human perfectly overlap then the probability that the user and the other human are in an interaction would be 1.0 (i.e., 100%).

In some examples, the computed overlap 502 may be further processed into an entropy metric (also referred to as entropy proxemic metric, a surprise metric or a load metric). In examples of the present disclosure, the entropy metric may be a numerical value that is computed based on an amount of overlap between a first proxemic PDF corresponding to a user's personal space and a second proxemic PDF corresponding to another human in proximity of the user. The entropy metric may thus be a numerical representation of the effect of the presence of the other human in the user's personal space. The entropy metric may be representative of the amount of surprise or cognitive load generated by the user interacting with the other human. Accordingly, the entropy metric may also be referred to as an interaction metric or an engagement metric. In some examples, the entropy metric may be computed using the following logarithmic function:

$$S = - {log}_{2} ( 1 - overlap ) \qquad Equation 1$$

where S denotes the entropy metric, and overlap is the computed amount of overlap 502 (e.g., using the above-discussed equation).

The entropy metric may represent the amount of cognitive load, stress or surprise that would be generated by the other human entering the user's personal space. The entropy metric may be predictive of what the user's physiological arousal (which may be detectable physiological signals indicating stress, excitement, surprise, etc.) would be for example if measured using biosensors such as heart rate sensors or electrodermal devices. The entropy metric may also be representative of the expected cognitive load generated by the other human entering the user's personal space. In particular, the increase in cognitive load may be reflective of the increased probability of an interaction (e.g., conversation) due to the close proximity of the other human in front of the user.

Notably, because the entropy metric is computed using binary logarithm, the entropy metric may be represented using bits. The result is that the entropy metric is an additive metric. That is, if the first PDF of the user is overlapped with multiple PDFs corresponding to respective multiple other humans, an amount of overlap may be computed between the first PDF and each other PDF, then the computed overlap amounts may be directly summed up to arrive at an entropy metric that represents an overall estimate of the cognitive load on the user due to the presence of all the other humans in the user's proximity. Similarly, if the first PDF of the user is overlapped by multiple PDFs that each represent a different possible interaction (e.g., different types of interaction with one other human, or different possible interactions with other humans), an amount of overlap may be computed between the first PDF and each other PDF, then the computed overlap amounts may be directly summed up to arrive at a entropy metric that represents an overall estimate of the cognitive load on the user due to the different possible interactions the user can engage in.

In some examples, different PDFs may be used to represent different types of interactions with the user (e.g., interpersonal interactions, peripersonal interactions, human-device interactions, etc.). Different entropy metrics may be computed for each type of interaction (e.g., based on overlaps between PDFs representing interpersonal or peripersonal space about the user) and used to estimate the likelihood that the user is engaged in a particular type of interaction. The electronic device may then manage notifications based on the type of interaction. For example, a first category of notifications (e.g., visual notifications) may be permitted when an interpersonal interaction is determined to be likely (e.g., there is significant overlap with an interpersonal space PDF of the user) while a second category of notifications (e.g., audio notifications) may not be permitted. However, when a peripersonal interaction is determined to be likely (e.g., there is significant overlap with a peripersonal space PDF of the user), then both the first and second categories of notifications may not be permitted. In this way, more nuanced management of notifications may be possible.

The entropy metric may be representative of the amount of uncertainty in a user's decision making process, for example being reflective of the difficulty of a possible social interaction (e.g., based on the uncertainty in fight or flight decisions by the parasympathetic and sympathetic nervous systems of the user). The entropy metric may also represent a proxy or estimate of the amount of information that can be transferred to the user and thus may be predictive of the actual capacity of the communication channel (referred to the capacity to clearly communicate information between humans) between the user and another human or between the user and the electronic device 100.

The present disclosure describes examples of how the entropy metric, computed using proxemic PDFs as described above, may be used to manage device notifications in addition to other possible applications.

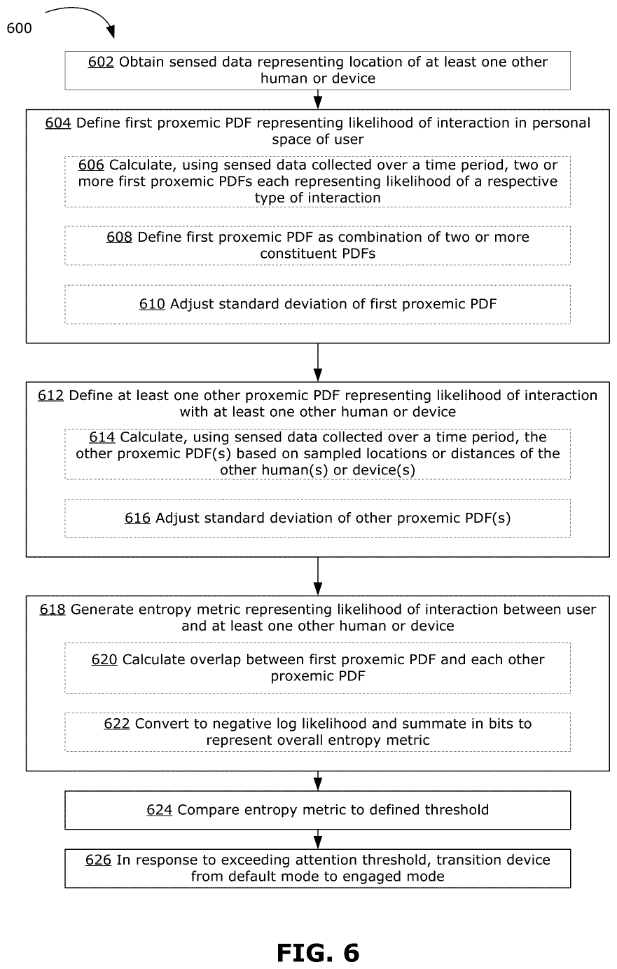

FIG. 6 is a flowchart illustrating an example method 600 for managing device notifications based on proxemic PDFs. The method 600 may be performed by an electronic device (e.g., the electronic device 100 of FIG. 1) of a user. For example, the method 600 may be performed by the processing unit 102 of the electronic device 100 executing instructions (e.g., instructions of the entropy metric module 110 and/or the notification management module 112) stored in the memory 108. In general, the processing unit 102 may be configured to execute suitable instructions to cause the electronic device 100 to perform the method 600.

At 602, sensed data is obtained (e.g., from one or more sensors of the electronic device 100 and/or from one or more sensors in communication with the electronic device 100, including but not limited to positioning systems such as mmWave radar units) representing a location of at least one other human or device. The sensed data may, for example, represent the location one or more other humans in the nearby environment (e.g., other humans may be sensed by environmental sensors in a smart home). The sensed data may, in another example, represent the location of one or more devices in the nearby environment (e.g., other devices may be broadcasting their position to the electronic device 100 and/or may be located by sensors). In some examples, the sensed data may also represent a location of the user of the electronic device 100.

The sensed data may represent locations in a fixed frame of reference (e.g., the GPS unit 122 of the electronic device 100 may provide the electronic device 100 with positioning data in a fixed frame of reference) and/or may represent relative locations (or relative distances) between the user and another human or device (e.g., the radar unit 124 or ultrasound unit 126 of the electronic device 100 may provide the electronic device 100 with relative distances to another human or device). In some examples, the electronic device 100 may communicate with another device (e.g., an IoT device in the environment, or a device carried by another human), for example via UWB transmission, Bluetooth, WiFi, etc., so that the relative distance between the two devices may be determined.

At 604, a first proxemic PDF is defined. The first proxemic PDF represents the likelihood of interaction in a personal space of the user, as discussed above. The first proxemic PDF may be a complex PDF (such as the social space PDF 240) or a relatively simple PDF (such as the simplified proxemic PDF 310). The first proxemic PDF may be defined to be a Gaussian distribution based on the sensed data, for example by using the location of the user (determined from the sensed data) as the origin and defining the mean of the first proxemic PDF to be at a certain distance and direction from the origin (e.g., one or two arm lengths in front of the origin). Sensed data may be collected over a defined time period (e.g., 1 s) and sensed changes in the user's position over this time may be used to define the standard deviation of the first proxemic PDF. Performing step 604 may include performing steps 606, 608 and/or 610.

At 606, defining the first proxemic PDF may include calculating two or more first proxemic PDFs (e.g., the term “first” may not be limited to a single proxemic PDF, but may be used to describe any proxemic PDF representing likelihood of interaction in the personal space of the user) where each first proxemic PDF represents a respective likelihood of a respective type of interaction in the personal space of the user. For example, an interpersonal space PDF 242 may be defined to represent the likelihood of an interpersonal interaction (e.g., conversation or other interaction conducted at a distance of one to two arms lengths away) with the user and additionally a peripersonal space PDF 244 may be defined to represent the likelihood of a peripersonal interaction (e.g., touching, performing a handshake, sharing a book or other interaction conducted at a distance within one arm length of the user). In general, different types of interactions (auditory, peripersonal, interpersonal, etc.) may be represented by different first proxemic PDFs.

The calculation at step 606 may be performed using sensed data collected over a defined time period (e.g., 1s). The sensed data collected over the time period may be used to determine changes in the position of the user. Changes in the position of the user may be used to define the standard deviation of each of the two or more first proxemic PDFs.

At 608, the first proxemic PDF may be defined as a combination of two or more constituent PDFs. For example, the first proxemic PDF may be a mixed Gaussian distribution that is the result of a summation of two or more constituent Gaussian distributions. For example, the constituent PDFs may be Gaussian PDFs that each represents a different type of interaction (such as the constituent PDFs 242, 244, 246 of FIG. 2) and may be summed to arrive at a more complex PDF that is used as the first proxemic PDF (such as the social space PDF 240).

At 610, the standard deviation of the first proxemic PDF (or its constituent PDFs) may be adjusted. For example, the standard deviation may be defined to be a certain value. If the standard deviation is defined based on measurements of the user's body (e.g., the user's arm length), the electronic device 100 may use sensors to obtain such measurements (e.g., the arm length of the user may be calibrated by sensing the distance between a sensor worn at the user's wrist and a sensor in an electronic device closer to the user's body). Other techniques for estimating the user's arm length or other measurements may be used. It should be noted that the mean and standard deviation of the first proxemic PDF may be defined depending on the type of interaction that is represented by the first proxemic PDF. For example, the standard deviation may be larger for a proxemic PDF that is intended to represent likelihood of an interpersonal interaction rather than a more intimate peripersonal interaction.

In some examples, the standard deviation of the first proxemic PDF may be adjusted dynamically and in real-time (or near real-time) based on sensed movement of the user, as discussed further below. For example, the electronic device 100 may obtain sensed data over a defined time period (e.g., over 1 s). The standard deviation of the first proxemic PDF may then be defined based on the changes in the user's position over this time period (e.g., the greater the user's change in position, the larger the standard deviation of the first proxemic PDF). Further, if the user's position changes in a particular direction (e.g., forwards), the standard deviation in that direction may be increased while the standard deviation in an opposite or perpendicular direction may be decreased.

It should be understood that steps 606, 608 and 610 may be performed together and/or in any order (including in parallel) to arrive at a final first proxemic PDF.

At 612, at least one other proxemic PDF is defined. The second proxemic PDF represents the likelihood of interaction with at least one other human or device. In some examples, if there are multiple other proxemic PDFs defined (e.g., corresponding to multiple other humans), the other proxemic PDFs may be referred to as “second” proxemic PDF, “third” proxemic PDF, etc. In general, an “other” proxemic PDF may refer to a proxemic PDF corresponding to any other human that is not the user of the electronic device 100 or any device other than the electronic device 100 that is performing the method 600. The other proxemic PDF(s) may each be a complex PDF (such as the social space PDF 240) or a relatively simple PDF (such as the simplified proxemic PDF 310). The step 612 may be performed using steps 614 and/or 616.

At 614, similar to the first proxemic PDF, each other proxemic PDF may be defined based on the sensed data collected over a defined time period (e.g., 1 s). In particular, the other proxemic PDF(s) may be determined, using sampled location or distance data of the other human(s) or device(s) collected over the time period. For example, the other proxemic PDF(s) may each be a Gaussian distribution, having a mean defined to be at a certain distance and direction from the sensed location of the other human or device. Generally, the electronic device 100 may have less information about the other human(s) or device(s) than about the user, accordingly the other proxemic PDF(s) may be more simplified compared to the first proxemic PDF (e.g., may be a simple Gaussian distribution instead of a mixed Gaussian distribution).

At 616, the standard deviation of each other proxemic PDF may be adjusted. For example, if the other proxemic PDF corresponds to another human, the standard deviation may be adjusted to a minimum of one standard arm length (e.g., based on the average arm length of an adult human). In another example, if the other proxemic PDF corresponds to another device, the standard deviation may be adjusted to a voice input range of the other device.

In some examples, if the other proxemic PDF corresponds to another human, changes in the sensed position of the other human over time may be used to adjust the standard deviation of the other proxemic PDF in real-time (or near real-time). Similar to the real-time adjustment of the standard deviation of the first proxemic PDF, the standard deviation of the other proxemic PDF may be defined based on the change and direction of the position of the other human (e.g., increased in the direction of the other human's movement).

It should be understood that steps 604 and 612 may be performed in any order, including in parallel.

At 618, an entropy metric is generated by computing an amount of overlap between the first proxemic PDF and the other proxemic PDF(s). The proxemic metric represents the likelihood of interaction between the user and the other human(s) and/or device(s) represented by the other proxemic PDF(s). Performing step 618 may involve performing steps 620 and/or 622.

At 620, the amount of overlap between the first proxemic PDF and each other proxemic PDF may be calculated. For example, if there are multiple other proxemic PDFs, then the overlap between the first proxemic PDF and a selected other proxemic PDF is calculated, the calculated overlap may be stored and another proxemic PDF may be selected. In this way overlaps between the first proxemic PDF and the other proxemic PDFs may be calculated one by one. The entropy metric may then be generated based on the summation of the calculated overlaps. As described above, the amount of overlap between the first proxemic PDF and each other proxemic PDF may be defined as the volume bounded by the first proxemic PDF, the other proxemic PDF and the x-y plane (i.e., the plane where probability of interaction is zero). Any suitable mathematical technique may be used to compute the amount of overlap. In some examples, the amount of overlap may be itself used as the proxemic metric.

If two or more first proxemic PDFs were defined to each represent likelihood of a respective type of interaction in the personal space of the user, then generating the entropy metric may include generating a respective entropy metric by computing the amount of overlap between one other proxemic PDF corresponding to another human and each respective one of the two or more first proxemic PDFs. Then each respective entropy metric may represent the likelihood of a respective type of interaction between the user and the other human. For example, if the two or more first proxemic PDFs include an interpersonal space PDF 242 representing likelihood of an interpersonal interaction and a peripersonal space PDF 244 representing likelihood of a peripersonal interaction, then a corresponding interpersonal entropy metric may be generated by computing the amount of overlap between the second proxemic PDF and the interpersonal space PDF 242 (where the interpersonal entropy metric may represent the likelihood of an interpersonal interaction between the user and the other human), and also a corresponding peripersonal entropy metric may be generated by computing the amount of overlap between the second proxemic PDF and the peripersonal space PDF 244 (where the peripersonal entropy metric may represent the likelihood of a peripersonal interaction between the user and the other human).

At 622, the entropy metric may be converted to a negative log likelihood (e.g., as shown in Equation 1), to obtain a bit-based entropy metric. If there are multiple entropy metrics (e.g., resulting from calculating multiple overlaps, such as for different types of interactions and/or interactions with different humans/devices), a bit-based summation may be performed to obtain an overall entropy metric.

At 624, the entropy metric is compared to a defined threshold, such as an attention threshold or a surprise threshold. For example, the electronic device 100 may store a defined threshold (which may be preset, may be manually set, etc.) for performing this comparison. In some examples, different defined thresholds may be stored by the electronic device 100 and an appropriate threshold may be selected for the comparison at step 624, depending on the type of interaction. For example, if the entropy metric represents a likelihood of interaction between the user and another human, a first threshold (corresponding to a threshold for human-human interactions) may be selected; if the entropy metric represents a likelihood of interaction between the user and a device, a different second threshold (corresponding to a threshold for human-device interactions) may be selected.

If the entropy metric is above the defined threshold, this may indicate that the user is highly likely to be engaged in an interaction with the other human and/or device, or that the user is likely to be experiencing a high cognitive load.

In some examples, the threshold may be learned using machine learning. For example, the entropy metric may be used as a loss function that may enable learning of a relationship between the value of the entropy metric and the level of user interaction with another human or device. Then the learned relationship may be used to define an appropriate entropy threshold for the user.

If there are multiple entropy metrics generated, corresponding to different types of interactions, each entropy metric may be compared to a respective threshold for the corresponding type of interaction. For example, the threshold defined for a peripersonal interaction may be lower than the threshold defined for an interpersonal interaction (e.g., to reflect that a user's cognitive load in a peripersonal interaction is likely to be higher than in an interpersonal interaction). Alternatively, multiple bit-based entropy metrics may be summed up (e.g., using bit-based summation) to obtain a single overall bit-based entropy metric, which may then be compared to one overall threshold.

At 626, in response to the entropy metric exceeding the defined threshold, the electronic device 100 is transitioned from a default mode to an engaged mode. In the default mode, the electronic device 100 may provide notifications via output unit(s) 130 according to normal device settings. When the electronic device 100 is in the engaged mode, the electronic device 100 may generate outputs based on the user being likely engaged in an interaction. In generally, in the engaged mode, the electronic device 100 is controlled to provide at least one output in a manner that is different than the manner in which that at least one output would be provided in the default mode. In some examples, the manner in which notifications and outputs are modulated in the engaged mode may be directly dependent on the entropy metric.

In some examples, the notification management module 112 may be executed to manage how notifications are provided in the default mode and in the engaged mode. The notification management module 112 may process the entropy metric, generated by the entropy metric module 110, to determine whether the entropy metric exceeds the defined threshold. If so, the notification management module 112 may cause the electronic device 100 to transition to the engaged mode in which at least one output is managed differently than in the default mode.

For example, the engaged mode may cause the electronic device 100 to output an online status indicating that the user is engaged or that the user should not be disturbed. In another example, the engaged mode may cause the electronic device 100 to mute one or more audible notifications. Additionally or alternatively, the engaged mode may cause the electronic device 100 to output audible notifications via a headset (that is connected to the electronic device 100 wirelessly or via wired connection) instead of a speaker 132.

The engaged mode may also cause the electronic device 100 to adjust operation of input unit(s) 120 and/or output units 130 (s) (including any input unit and/or output unit that is connected to the electronic device 100 wirelessly or via wired connection). For example, the electronic device 100 may decrease or increase noise cancellation of a headset when in the engaged mode. The control of noise cancellation may be based on the value of the entropy metric (e.g., noise cancellation may be proportionate to the value of the entropy metric)) or may be simply turning on or off noise cancellation when in the engaged mode. Whether noise cancellation is increased or decreased when in the engaged mode may depend on the application being executed by the electronic device 100. For example, if the electronic device 100 is executing a media application (e.g., a music player or video player), noise cancellation may be increased (or turned on) in the engaged mode so that the user can focus on the media output. In another example, if the electronic device 100 is executing a hearing aid application where the headset is being used as a hearing aid, noise cancellation may be decreased (or turned off) in the engaged mode to help the user better hear sounds (such as a human conversation) in their environment. In such applications the source of the microphone input may be switched to receive voice input from the other human(s) corresponding to the other proxemic PDF(s) that significantly overlap with the first proxemic PDF. Additionally, the audio levels of the electronic device 100 may be controlled to be proportional to the entropy metric. In some examples, instead of controlling noise cancellation based on the entropy metric, when the electronic device 100 is in the engaged mode a noise cancellation mode (e.g., based on an artificial intelligence algorithm) may be activated.

In some examples, if the first proxemic PDF significantly overlaps with another proxemic PDF corresponding to another device (i.e., the entropy metric calculated from such an overlap exceeds the defined threshold), the electronic device 100 may command the other device based on the user being likely to interact with the other device. For example, the electronic device 100 may, in response to the entropy metric indicating a likely interaction with the other device, communicate a command to the other device to activate its microphone so as to be receptive to possible voice input from the user. In another example where there are multiple devices that the user may interact with, the entropy metric may indicate that a particular device is a likely interaction target of the user. The electronic device 100 may then communicate a command to that particular device to activate its microphone, because that particular device is a likely recipient of any voice inputs from the user.

Although examples of the present disclosure have described the use of proxemic PDFs to estimate the likelihood of interaction between the user and another human, the present disclosure also encompasses the use of proxemic PDFs to estimate the likelihood of interaction between the user and another device (e.g., another computing system or electronic system, including a desktop computer, a laptop, a smartphone, smart television, Internet of Things (IoT) device, etc.). For example, the other device may have a distance sensor or positioning sensor (e.g., a GPS unit, radar unit, ultrasound unit, etc.) that enables the location of the other device to be detected. The user's electronic device 100 may communicate with the other device (e.g., via Bluetooth, UWB or other such short range communication) to detect the location of the other device. Then the overlap between the first proxemic PDF corresponding to the user and a second proxemic PDF corresponding to the other device may be computed and used for an entropy metric that represents likelihood of the user interacting with the other device. In such a scenario, if the entropy metric exceeds the attention threshold, the electronic device 100 may transition to an engaged mode in which notifications that are normally outputted by the electronic device 100 may instead be outputted to the other device for example. In another example, the electronic device 100 may automatically establish a wireless connection or communication link with the other device, for example to share information (e.g., in a peer-to-peer session). In another example, the electronic device 100 may automatically configure itself to serve as an access point for the other device.

It should be understood that notifications may be managed in various ways when the electronic device 100 transitions from the default mode to the engaged mode. For example, in the default mode the electronic device 100 may be able to receive forwarded messages (or other data) whereas in the engaged mode the electronic device 100 may not be able to receive forwarded messages (or other data), or forwarded messages (or other data) may be received but hidden on the electronic device 100 (e.g., no notification is generated) until the electronic device 100 transitions from the engaged mode back to the default mode.

In some examples, when the electronic device 100 is in the engaged mode, audible notifications may be muted and/or visual notifications may be hidden. Such notifications may be provided at a future time when the electronic device 100 transitions from the engaged mode back to the default mode.

In some examples, the electronic device 100 may have different types of engaged mode. For example, the electronic device 100 may transition to an interpersonal engaged mode when the entropy metric (which may be computed based on a second proxemic PDF overlapping with a user's interpersonal space PDF 242) indicates the user is likely to be in an interpersonal interaction, and the electronic device 100 may transition to a peripersonal engaged mode when the entropy metric (which may be computed based on a second proxemic PDF overlapping with a user's peripersonal space PDF 244) indicates the user is likely to be in a peripersonal interaction. The electronic device 100 in the interpersonal engaged mode may mute audible notifications and may display visual notifications; the electronic device 100 in the peripersonal engaged mode may mute audible notifications and may hide visual notifications. Thus, the use of proxemic PDFs to represent different types of possible interactions the user may be engaged in may enable the electronic device 100 to perform notification management in a more nuanced manner that may balance user privacy with user convenience.

In some examples, transitioning to the engaged mode may cause the electronic device 100 to interact with other devices in a different manner. For example, if the other human in the user's proximity has another device (which may be another instance of the electronic device 100), the electronic device 100 in the engaged mode may cooperate with the other device such that audio input received at the other device may be outputted via the speaker 132 of the electronic device 100 or a headset connected to the electronic device 100.

In various examples, the present disclosure describes the use of proxemic PDFs to represent the likelihood of interactions in a user's personal space. An entropy metric is disclosed based on overlap between two (or more) proxemic PDFs, where the value of the entropy metric corresponds to the amount of overlap between the first proxemic PDF of a user and the second proxemic PDF of another human (or another device). The entropy metric may be used to control the state of the electronic device (which may be a laptop, tablet, smartphone, smartwatch, etc.), for example to transition the electronic device from a default mode to an engaged mode. The electronic device in the engaged mode may manage notifications and/or other outputs in a manner differently than in the default mode. In general, the engaged mode may cause the electronic device to reduce or otherwise filter notifications and/or other outputs in a way that takes into account the high likelihood that the user is interacting with another human (e.g., in a way that helps to preserve the privacy of the user, helps to avoid interrupting the user's interaction with the other human, etc.). This includes, for example, modulation of visible, haptic and/or audible notification methods. This may also include, for example, changing the modality of notification output (e.g., changing an audible notification to a visual notification or haptic notification) and/or changing the output channel of the notification (e.g., outputting an audible notification via a user's headset rather than a speaker of the electronic device, or outputting a visual notification via a user's smart glasses rather than a display of the electronic device).

Examples of the present disclosure may enable a user's level of interaction to be estimated using positioning data and without requiring the use of cameras, microphones or other possibly invasive tracking technologies. The entropy metric disclosed herein may, in addition to representing the likelihood of a user's interaction, be representative of a user's cognitive load. Accordingly, the entropy metric may be relatable to other metrics such as bits of difficulty of a task, and are additive. As such, the user's interaction, surprise or arousal may be estimated and quantified based on relative positioning using, for example, KL divergence, Jensen divergence, or other metrics discussed herein. Using the entropy metric as a representation of the user's cognitive load may enable the electronic device to be more adaptive to the user's current mental state (e.g., by reducing the distraction to the user when the user is likely to be interacting with another human). Additionally, because the entropy metric is a quantifiable value that may be represented using bits, it may be possible to quantify the number of information bits that can be presented to the user, based on the user's estimated cognitive load, such that the user is not overwhelmed while at the same time the amount of information presented to the user is not overly reduced.

Compared to some existing techniques for measuring cognitive load, such as requiring the user to fill out a questionnaire, measuring physiological signals (e.g., galvanic skin response, heart rate variability, eyetracking, etc.) or using overhead cameras, the entropy metric disclosed herein may be more dynamic (e.g., can be quickly computed to reflect the real-time situation of the user), less invasive of privacy and/or require fewer hardware components. Thus, the present disclosure may provide a more practical and convenient solution that may be more readily accepted by a user, and that may also be more robust and/or more widely applicable to different environments (e.g., including outdoor environments that may not be suitable for tracking systems).

Examples of the present disclosure may enable notification management that accounts for the user's possible interactions without requiring tracking of the user or other humans in the environment, which may be advantageous from a privacy perspective. If there is data exchanged between devices (e.g., exchange of positioning data, in order to determine relative distance between humans), privacy and/or security may be achieved through the use of ad-hoc connections between devices or between positioning sensors where exchange of data is kept private, for example through the use of hashing. Any data exchanged in this manner may automatically expire when devices are no longer in proximity.

Examples of the present disclosure describe the use of proxemic PDFs which may dynamically change based on the user's movement (e.g., the standard deviation of the proxemic PDF may increase in the direction of the user's movement). This may enable more accurate and/or more sensitive detection of a user's likely interaction based on the user's velocity. This may not be achieved by existing solutions that only consider the user's position or distance. Existing solutions may not be able to quantify the probability of interaction for a user, or may not be able to perform such quantification in a real-time manner. Further, existing solutions may not be suitable to be used as a quantified estimate of the user's surprise, arousal, or cognitive load (e.g., in bits).

Additionally, the ability to dynamically adapt the standard deviation of the proxemic PDF based on the user's movement provides a real-time quantification of the user's level of interaction, which may be able to capture transient scenarios that may not be captured by existing solutions. Because the presence of other humans in the user's personal space may be quickly changing (e.g., due to movement of other humans in the environment and/or the user's movement through the environment), it is important for the proxemic PDF to be defined in real-time and for the standard deviation of the proxemic PDF to be adjusted in real-time, in order to be an accurate reflection of the user's situation. As such, a computer-based solution is required. The examples of the present disclosure thus may not be possible using manual means only.

Examples of the present disclosure define different proxemic PDFs for a user to represent the probability of different types of interaction (e.g., peripersonal interaction or interpersonal interaction). The ability to determine between different types of interactions in a quantifiable way may be advantageous over existing solutions, for example by enabling more nuance management of device notifications.

The entropy metric may also be an additive metric that can be represented using bits. This may enable the user's probability of interaction to be computed using a relatively simply summation of multiple computed entropy metrics related to different possible types of interactions. This means that a user's overall cognitive load or overall probability of interaction can be estimated, even in complex scenarios (e.g., multiple persons and/or devices in the user's proximity that can be possible interactions for the user). Accordingly, the electronic device may be able to efficiently manage notifications to suit the user's situation even in complex environments.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method, at an electronic device associated with a user, the method comprising:
obtaining, from one or more sensors, sensed data representing a sensed location of the user and at least one other human or at least one other device;
defining a first proxemic probability density function (PDF) representing likelihood of interaction in a personal space of the user, the first proxemic PDF being defined using the sensed location of the user;
defining at least one other proxemic PDF representing likelihood of interaction with the at least one other human or the at least one other device, the at least one other proxemic PDF being defined using the sensed location of the at least one other human or the at least one other device;
generating an entropy metric representing likelihood of interaction between the user and the at least one other human or the at least one other device by computing an overlap between the first proxemic PDF and the at least one other proxemic PDF; and
in response to the entropy metric exceeding a defined threshold, transitioning the electronic device from a default mode to an engaged mode, wherein in the engaged mode the electronic device is controlled to provide at least one output differently than in the default mode.

2. The method of claim 1, wherein the first proxemic PDF is defined to be a Gaussian distribution having a mean based on the sensed location of the user, and wherein a standard deviation of the first proxemic PDF is adjusted based on at least one of: an estimated arm length of the user or changes in the sensed location of the user.

3. The method of claim 1, wherein the first proxemic PDF is defined to comprise two or more constituent PDFs, wherein each constituent PDF represents likelihood of a respective type of interaction in the personal space of the user.

4. The method of claim 3, wherein the first proxemic PDF is a mixed Gaussian distribution and each of the two or more constituent PDFs is a respective Gaussian distribution.

5. The method of claim 1, wherein the at least one other proxemic PDF represents likelihood of interaction with the at least one other human, wherein the at least one other proxemic PDF is defined to be a Gaussian distribution having a mean based on the sensed location of the at least one other human, and wherein a standard deviation of the at least one other proxemic PDF is adjusted based on at least one of: an estimated arm length of the at least one other human or changes in the sensed location of the at least one other human.

6. The method of claim 5, wherein the entropy metric represents likelihood of a particular type of interaction with the at least one other human, and the electronic device is transitioned to the engaged mode dependent on the type of interaction.

7. The method of claim 5, wherein the sensed data represents sensed locations of a plurality of other humans, wherein there is a respective plurality of other proxemic PDFs representing likelihood of interaction with the respective plurality of other humans, and wherein the entropy metric is generated based on overlaps between the first proxemic PDF and each other proxemic PDF.

8. The method of claim 7, wherein, in response to the entropy metric indicating significant overlaps between the first proxemic PDF and two or more other proxemic PDFs corresponding to two or more other humans, the electronic device is transitioned to the engaged mode wherein the electronic device is controlled to interact with two or more other devices associated with the two or more other humans.

9. The method of claim 1, wherein the at least one other proxemic PDF represents likelihood of interaction with the at least one other device, and the at least one other proxemic PDF is defined to be a Gaussian distribution having a mean based on the sensed location of the at least one other device.

10. The method of claim 9, wherein the sensed data represents sensed locations of a plurality of other devices, wherein there is a respective plurality of other proxemic PDFs representing likelihood of interaction with the respective plurality of other devices, and wherein a respective plurality of entropy metrics is generated to represent likelihood of interaction with the respective plurality of other devices.

11. The method of claim 1, wherein the entropy metric is represented in binary bits.

12. The method of claim 1, wherein in the engaged mode the electronic device is controlled to adjust the at least one output proportionate to a value of the entropy metric.

13. An electronic device comprising:
a processing unit; and
a memory including instructions that, when executed by the processing unit, cause the electronic device to:
obtain, from one or more sensors, sensed data representing a sensed location of the user and at least one other human or at least one other device;
define a first proxemic probability density function (PDF) representing likelihood of interaction in a personal space of the user, the first proxemic PDF being defined using the sensed location of the user;
define at least one other proxemic PDF representing likelihood of interaction with the at least one other human or the at least one other device, the at least one other proxemic PDF being defined using the sensed location of the at least one other human or the at least one other device;
generate an entropy metric representing likelihood of interaction between the user and the at least one other human or the at least one other device by computing an overlap between the first proxemic PDF and the at least one other proxemic PDF; and
in response to the entropy metric exceeding a defined threshold, transition the electronic device from a default mode to an engaged mode, wherein in the engaged mode the electronic device is controlled to provide at least one output differently than in the default mode.

14. The device of claim 13, wherein the first proxemic PDF is defined to be a Gaussian distribution having a mean based on the sensed location of the user, and wherein a standard deviation of the first proxemic PDF is adjusted based on at least one of: an estimated arm length of the user or changes in the sensed location of the user.

15. The device of claim 13, wherein the first proxemic PDF is defined to comprise two or more constituent PDFs, wherein each constituent PDF represents likelihood of a respective type of interaction in the personal space of the user.

16. The device of claim 13, wherein the at least one other proxemic PDF represents likelihood of interaction with the at least one other human, wherein the at least one other proxemic PDF is defined to be a Gaussian distribution having a mean based on the sensed location of the at least one other human, and wherein a standard deviation of the at least one other proxemic PDF is adjusted based on at least one of: an estimated arm length of the at least one other human or changes in the sensed location of the at least one other human.

17. The device of claim 16, wherein the entropy metric represents likelihood of a particular type of interaction with the at least one other human, and the electronic device is transitioned to the engaged mode dependent on the type of interaction.

18. The device of claim 13, wherein the at least one other proxemic PDF represents likelihood of interaction with the at least one other device, and the at least one other proxemic PDF is defined to be a Gaussian distribution having a mean based on the sensed location of the at least one other device.

19. The device of claim 13, wherein the entropy metric is represented in binary bits.

20. A non-transitory computer readable medium having machine-executable instructions stored thereon, wherein the instructions, when executed by an electronic device, cause the electronic device to:
obtain, from one or more sensors, sensed data representing a sensed location of the user and at least one other human or at least one other device;
define a first proxemic probability density function (PDF) representing likelihood of interaction in a personal space of the user, the first proxemic PDF being defined using the sensed location of the user;
define at least one other proxemic PDF representing likelihood of interaction with the at least one other human or the at least one other device, the at least one other proxemic PDF being defined using the sensed location of the at least one other human or the at least one other device;
generate an entropy metric representing likelihood of interaction between the user and the at least one other human or the at least one other device by computing an overlap between the first proxemic PDF and the at least one other proxemic PDF; and
in response to the entropy metric exceeding a defined threshold, transition the electronic device from a default mode to an engaged mode, wherein in the engaged mode the electronic device is controlled to provide at least one output differently than in the default mode.
